(19) United States
(12) Patent Application Publication
(10) Pub. No.: US 2009/0234751 A1
(43) Pub. Date: Sep. 17, 2009

(54) ELECTRONIC WALLET FOR A WIRELESS MOBILE DEVICE

(76) Inventors: Eric CHAN, Toronto (CA); David CASTELL, Waterloo (CA)

Correspondence Address: FASKEN MARTINEAU DUMOULIN LLP, 4200 TORONTO DOMINION BANK TOWER, BOX 20 TORONTO-DOMINION CENTRE, TORONTO, ON, M5K 1N6, CA

(21) Appl. No.: 12/116,173

(22) Filed: May 6, 2008

Related U.S. Application Data
(60) Provisional application No. 61/036,611, filed on Mar. 14, 2008.

(51) Int. Cl. G06Q 40/00; G06Q 30/00

(52) U.S. Cl. 705/26; 705/35

(57) ABSTRACT

There is disclosed an electronic wallet for a wireless mobile device, and a method of operating the electronic wallet. In an embodiment, the electronic wallet comprises wallet invocation means responsive to an external trigger originating externally from the wallet; user authentication means for authenticating the user of the electronic wallet upon invocation of the wallet by the external trigger; and means for returning card information stored in the wallet in dependence upon a form specified by the external trigger invoking the wallet. The external trigger may be a webpage accessed via an Internet web browser on the wireless mobile device, the webpage having a wallet trigger instruction embedded therein. The wallet trigger instruction may be an extension embedded into the header of the webpage accessed via the Internet web browser. The webpage may further include field ID tags mapping specific data fields in the wallet to form input fields provided in the webpage.

### RELATED APPLICATION INFORMATION

This application claims the benefit of U.S. Provisional Patent Application No. 61/036,611 filed Mar. 14, 2008, the disclosure of which is incorporated herein by reference in its entirety.

### FIELD OF THE INVENTION

The present disclosure relates generally to electronic wallets for wireless mobile devices.

### BACKGROUND

Currently, there are a number of ways in which online transactions may be made via a wireless mobile device. For example, using an Internet browser, a user of the wireless mobile device may browse an online store, and the store may allow the user to create a name/password and to save the credit card information at the online store for future purchases. Alternatively, form-filler functionality may be provided on the wireless mobile device with credit card support (e.g. Windows Live™ Toolbar includes credit card form filling options with password protection).

### BRIEF DESCRIPTION OF THE DRAWINGS

In the figures which illustrate exemplary embodiments:

FIG. 1 is an illustration of a device in accordance with an embodiment;

FIG. 2 is an illustrative example of a wireless mobile device that may provide an operating environment;

FIG. 3 is a schematic block diagram of an illustrative example of a network environment in which various embodiments may be practiced;

FIG. 4 shows a schematic block diagram of an illustrative electronic purchase system that may be conducted using the wireless mobile device and an electronic wallet in accordance with an embodiment;

FIG. 5 is a schematic block diagram of an electronic wallet architecture in accordance with an embodiment;

FIG. 6 is a schematic flowchart of an illustrative method for accessing a password protected wallet in accordance with an embodiment;

FIG. 7 is a schematic flowchart of a method for adding a new card, or editing an existing card to the electronic wallet in accordance with an embodiment;

FIG. 8 is a schematic flowchart of a method for invoking the electronic wallet in accordance with an embodiment; and

FIG. 9 is a schematic block diagram of a method for deleting a card from the electronic wallet in accordance with an embodiment.

### DETAILED DESCRIPTION

As noted above, the present disclosure relates to an electronic wallet for a wireless mobile device.

Prior approaches require a user to provide the required information each time if they choose not to save their information at an e-commerce website, and therefore making an online purchase may be cumbersome. What is needed is an improved electronic wallet for a wireless mobile device.

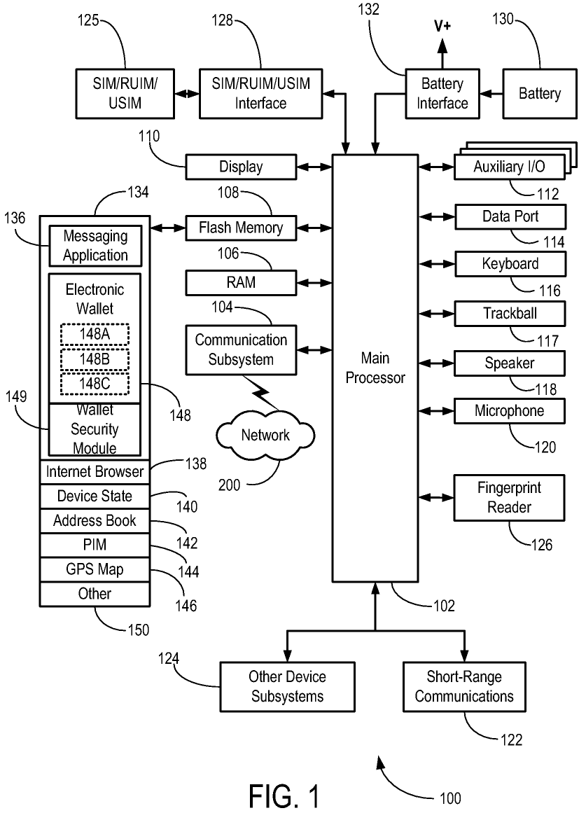

Shown in FIG. 1 is a schematic block diagram of an illustrative wireless mobile device 100. The wireless mobile device 100 may comprise a number of components, including a main processor 102 which controls the overall operation of wireless mobile device 100. Communication functions, including data and voice communications, may be performed through a communication subsystem 104. The communication subsystem 104 may receive messages from and send messages to a wireless network 200.

The main processor 102 may also interact with additional subsystems such as a random access memory (RAM) 106, a flash memory 108, a display 110, an auxiliary input/output (I/O) subsystem 112, a data port 114, a keyboard 116, a trackball 117, a speaker 118, a microphone 120, short-range communications 122, other device subsystems 124, SIM/RUIM/USIM card 125 connected via a SIM/RUIM/USIM interface 128, and a fingerprint reader module 126. In some embodiments, the keyboard 116 may comprise a virtual keyboard or a physical keyboard or both. In some embodiments, the display 110 may comprise a touchscreen display.

Some of the subsystems of the wireless mobile device 100 may perform communication-related functions, whereas other subsystems may provide “resident” or on-device functions. By way of example, the display 110 and the keyboard 116 may be used for both communication-related functions, such as entering a text message for transmission over the network 200, and device-resident functions such as a calculator or task list. The trackball 117 may be used for various navigation functions, such as navigating through a graphical user interface (GUI) menu displayed on display 110. The trackball 117 may also be configured with a secondary actuation feature, such as allowing for the trackball to be depressed, to allow selection of a highlighted item.

Still referring to FIG. 1, operating system software used by the main processor 102 is typically stored in a persistent store such as flash memory 108. Those skilled in the art will appreciate that the operating system, specific device applications, or parts thereof, may be temporarily loaded into a volatile store, such as the RAM 106, for processing by main processor 102.

The wireless mobile device 100 may send and receive communication signals over the wireless network 200 after required network registration or activation procedures have been completed. Network access may be associated with a subscriber or user of the wireless mobile device 100.

The wireless mobile device 100 may be a battery-powered device and may include a battery interface 132 for receiving one or more rechargeable batteries 130. In some embodiments, the battery 130 may be a smart battery with an embedded microprocessor. The battery interface 132 is coupled to a regulator (not shown), which assists the battery 130 in providing power V+to the wireless mobile device 100. The battery 130 may be used to power all components and modules in the wireless mobile device 100. In some embodiments, the communication device 100 may be solar powered or otherwise powered with or without use of a battery.

The main processor 102, in addition to its operating system functions, enables execution of various software applications 134 on the wireless mobile device 100. A subset of software applications 134 that control basic device operations, including data and voice communication applications, will normally be installed on the wireless mobile device 100 during its manufacture.

The software applications 134 may include a messaging application 136. The messaging application 136 can be any suitable software program that allows a subscriber or user of the wireless mobile device 100 to send and receive wireless text communications. Various alternatives exist for the messaging application 136 as is well known to those skilled in the art. Messages that have been sent or received by the user are typically stored in local storage such as flash memory 108 of the wireless mobile device 100, or in some other suitable storage element in the wireless mobile device 100. In an alternative embodiment, some of the sent and received messages may be stored remotely from the wireless mobile device 100 such as in a data store of an associated host system that the wireless mobile device 100 communicates with. In an embodiment, the messaging application 136 may include a Message List user interface that is configured to allow a user to see a list of message objects (i.e. email messages) in a convenient list form. This will be described in detail further below.

Still referring to FIG. 1, wireless mobile device 100 may include an electronic wallet 148 that may be operatively integrated with main processor 102, RAM 106, display 110, short-range communications subsystem 122, fingerprint reader module 126, or various other device subsystems 124 and software applications 134 to provide various electronic wallet application functions.

To identify a user, the communications device 100 may use a SIM/RUIM/USIM card 125 (i.e. Subscriber Identity Module or a Removable User Identity Module or a Universal Subscriber Identity Module, etc.), which is inserted into a SIM/RUIM/USIM interface 128, to communicate with a network. The SIM/RUIM/USIM card 125 is one type of a conventional “smart card” that can be used to identify a user of the communications device 100 and to personalize the communications device 100, among other things. Without the SIM/RUIM/USIM card 125, the communications device 100 may not be fully operational for communication with the wireless network 200, in some embodiments. By inserting the SIM/RUIM/USIM card 125 into the SIM/RUIM/USIM interface 128, a user can access subscribed services. Such subscribed services may include, for example, web browsing and messaging such as email, voice mail, Short Message Service (SMS), and Multimedia Messaging Services (MMS).

The wireless mobile device 100 may further include a device state module 140, an address book module 142, a Personal Information Manager (PIM) module 144, and various other modules 150. Additional software applications may also be loaded onto the wireless mobile device 100 through at least one of the wireless network 200, the auxiliary I/O subsystem 112, the data port 114, the short-range communications subsystem 122, or the various other device subsystems 124.

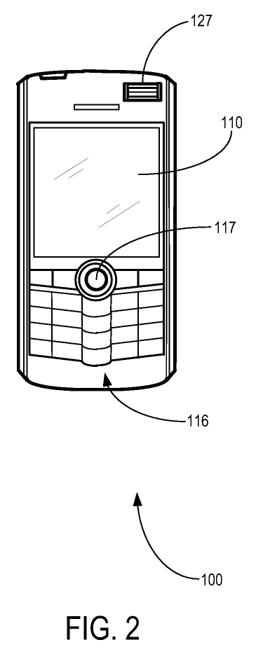

Now referring to FIG. 2, shown is an illustrative front view of a wireless mobile device 100 that may provide a suitable operating environment. In this particular example, mobile communication device 100 comprises a handheld smart phone; however, the scope of the present disclosure is not limited to a specific type of device. As shown, the wireless mobile device 100 may include a display 110, a keyboard 116, and other input or navigation means such as a trackball 117, and a fingerprint reader 127 operatively connected to the fingerprint reader module 126 of FIG. 1. The display 110 may be configured to display various screens allowing the user of device 100 to view screen outputs from the various software applications 134, including the electronic wallet 148. Display 110 may also be configured to provide a touch-sensitive screen input in response to a prompt or query displayed on display 110.

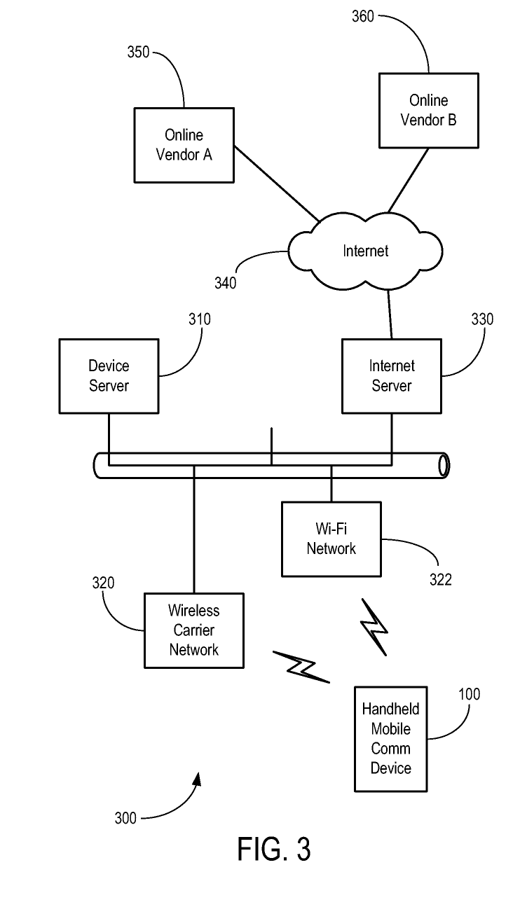

Now referring to FIG. 3, shown is a schematic block diagram of an illustrative network environment 300 in which various embodiments may be practiced. As shown, network environment 300 may include a device server 310 operatively connected to the wireless mobile device 100 via a wireless carrier network 320, a Wi-Fi Network 322, or another suitable access point. Any data transferred between device server 310 and wireless mobile device 100 may be encrypted using algorithms such as Triple Data Encryption Standard (Triple DES) and Advanced Encryption Standard (AES), which use 112-bit keys and 256-bit keys respectively, to secure wireless communications.

An Internet server 330 may also be provided in the network environment 300 such that device 100 may access the Internet 340. In an embodiment, the Internet 340 may provide access to online vendors having web servers 350, 360 from which a user of wireless mobile device 100 may electronically purchase goods or services.

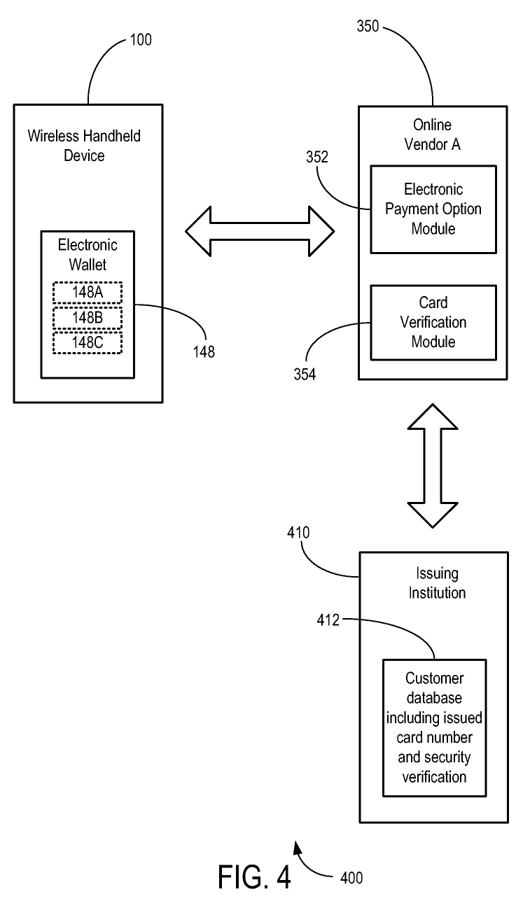

Now referring to FIG. 4, shown is a schematic block diagram 400 of an illustrative electronic purchase system that may be conducted using the wireless mobile device 100 and the electronic wallet 148 in accordance with an embodiment. Presently, some online vendors allow a user visiting their website to create a login and password, and will hold credit card information supplied by the user for future purchases. But, this may require the user of wireless mobile device 100 to provide each such online vendor with the user's credit card information and other personal information, and to trust the online vendor to store their credit card and personal information indefinitely. When the credit card expires, it would have to be updated as well at each vendor site at which the credit card information has been previously supplied. This inconvenience may cause the user of wireless mobile device 100 to find alternative methods of making the purchase, which may entail more costly transactions for the user or vendor or both.

As shown, the electronic wallet 148 may be configured to access storage means on a persistent store (e.g. flash memory 108) adapted to securely store data for one or more payment cards (e.g. credit cards or debit cards 148A, 148B, 148C) issued to the user of wireless mobile device 100.

In an embodiment, the online vendor may provide a web server 350 having an electronic payment module 352 suitably configured to enable purchases from the online vendor's website using the electronic wallet 148 carried within wireless mobile device 100. The electronic payment module 352 may provide a user interface viewable on display 100 of wireless mobile device 100, and various menu options and controls may be presented for selection or activation using keyboard 116 or trackball 117. The online vendor 350 may also have a card verification module 354, for verifying the authenticity of a card used for purchase on the online vendor's web server 350.

Still referring to FIG. 4, an issuing institution 410 may provide services for verifying the authenticity of a card issued by the issuing institution to an end user of the wireless mobile device 100. As shown, issuing institution 410 may have a customer database 412 including issued card numbers, and security verification information, such as a card verification number or CVN.

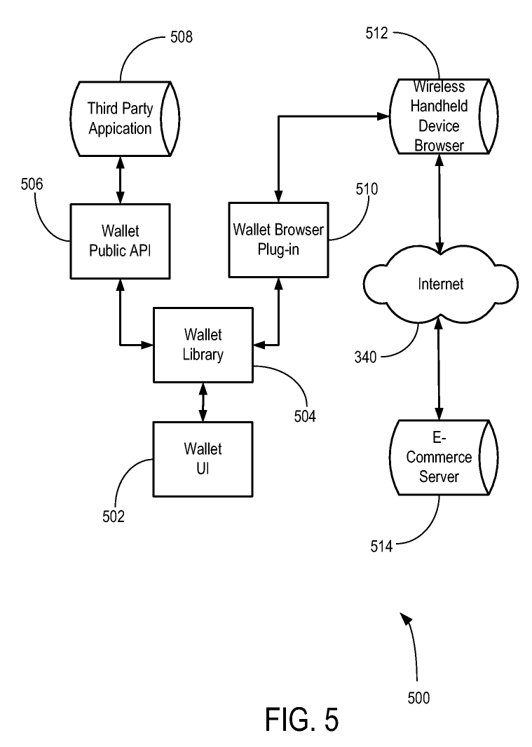

Now referring to FIG. 5, an illustrative electronic wallet architecture 500 in accordance with an embodiment will now be described. For the purposes of the present discussion, the following terms and acronyms will have the noted definitions:

AES—Advanced Encryption Standard (AES) is a block cipher used to encrypt/decrypt information.

SHA—Secure Hash Algorithm (SHA) is a hash function for one-way information mapping. SHA-256 is a particular version of SHA computed with 32-bit words. Other versions are also available.

HTML—Hypertext Mark-up Language is currently the predominant mark-up language for web pages.

HTTP—Hypertext Transfer Protocol (HTTP) is a communications protocol used to transfer or convey information on the Internet.

HTTP POST—Submits data to be processed (e.g. from an HTML form) to the identified resource. The data is included in the body of the request. This may result in the creation of a new resource or the updates of existing resources or both.

HTTP GET—Requests a representation of the specified resource. This is the most common method used on the Internet today.

HTTPS—HTTPS is a URI scheme used to indicate a secure HTTP connection.

URI—Uniform Resource Identifier (URI) is a compact string of characters used to identify or name a resource. The main purpose of this identifier is to enable interaction with representations of the resource over a network, typically the Internet, using specific protocols.

URL—Uniform Resource Locator (URL) is a URI that in addition to identifying a resource, provides a means of locating the resource by describing its primary access mechanism.

MIME—Multipurpose Internet Mail Extensions is an Internet Standard that extends the format of e-mail to support header information in non-ASCII characters set and text in character sets in other than US-ASCII.

As will now be explained, the primary actors on the electronic wallet architecture 500 are the wallet application developer, wallet client developer, e-commerce website developer, and the end user (i.e. the user of the wireless mobile device 100).

Generally speaking, the wallet application developer and the e-commerce website developer are separate parties. The wallet client developer may be a separate party, but may also be the wallet application developer. As the descriptive titles suggest, the wallet application developer develops the electronic wallet application. The wallet client developer creates a wallet client application which interacts between the electronic wallet core 504 and third party application 508. The e-commerce website developer develops the third party website (e.g. online vendor's web server 350), and is responsible for ensuring that the website can utilize the functions of the electronic wallet application.

Still referring to FIG. 5, a wallet UI 502 provides the user with a user interface to input information to the wallet application. For example, the wallet UI 502 is configured to allow the user to change the electronic wallet master password, add a new card, or edit or delete a stored card. An electronic wallet core 504 is the driver of the electronic wallet application. The electronic wallet core 504 stores all of the card information and also provides business logic and flow to the wallet application process. When a new card is added to the electronic wallet core 504, the wallet application will verify the following: The credit card number, credit card holder first/last name, security code (e.g. CVN code), and expiration date. The wallet core 504 may further verify the phone number, and any other information deemed to be necessary to authenticate the user.

The electronic wallet core 504 may also be operatively connected to a wallet public API 506, which stores and handles various interfaces for third party applications 508 to access the electronic wallet core 504. The electronic wallet core 504 also handles the authentication of the user, as will be described in more detail below.

In an embodiment, the electronic wallet core 504 monitors or listens to the Internet web browser 138 on the wireless mobile device 100 for a preconfigured wallet trigger instruction embedded in a webpage loading into the Internet web browser 138. The wallet trigger instruction is suitably configured to invoke the electronic wallet core 504 when a user of the wireless mobile device 100 visits a website via the Internet web browser 138. Thus, in this illustrative example, the external trigger is a webpage at a third party e-commerce site having a wallet trigger instruction embedded in the webpage header.

As an illustrative example, the wallet trigger instruction may be a MIME (Multimedia Internet Mail Extensions) type protocol embedded in the webpage HTTP header. Upon being invoked, the electronic wallet core 504 presents an authentication process that must be successfully completed by the user before the user can access the contents of the electronic wallet core 504. This authentication process will be described in more detail further below. However, without successful authentication, no further access to the electronic wallet application will be permitted.

In an embodiment, the webpage having the embedded wallet trigger instruction in its header may be a “check-out” page having a fillable form. Once a user has been authenticated, the electronic wallet core 504 may parse the HTML protocol in the check-out page, and take note of any field ID tags provided in the form input fields. The “check-out” page may also provide a number of payment options accepted by the third party e-commerce website. Once a user has selected a suitable card from the electronic wallet core 504 for use in payment, the electronic wallet core 504 will populate the fillable form on the check-out page based on a mapping of the card information stored in the electronic wallet core 504 to the appropriate form input fields using the field ID tags. This will now be described in more detail.

When invoked as described above, and the authentication process has been completed, the electronic wallet core 504 is adapted to recognize a number of field ID tags embedded in the HTML code from the webpage loaded from the third party e-commerce website. In an embodiment, these field ID tags may be configured to map specific data fields in the electronic wallet core 504 to information required by specific form input fields in the fillable form provided at the e-commerce website. For example, the field ID tags may map each of a credit card number, a card holder name, an expiry date, a card verification code, etc. from data fields in the electronic wallet core 504 to form input fields corresponding to the credit card number, card holder name, expiry date, and card verification code.

In an embodiment, the electronic wallet core 504 may include vector data types for storing various bits of card information. In an embodiment, the data inside the vector data types may be encrypted with an AES encryption scheme using a hashed master password as part of a symmetric key generation process. Another random number may be used as the second part of the key, and may be stored inside persistent storage in an unencrypted form.

The data type used in the electronic wallet core 504 should generally be compatible with the form input fields provided at the third party e-commerce website, or a suitable data type conversion module should be provided. The field ID tags are used for mapping. The field ID tags may be used to determine whether the fillable forms at the third party e-commerce website may receive these data types directly, or whether a conversion of the data type may be required. If data conversion is required, this may be done by the electronic wallet core 504, using a suitable data type conversion module. Alternatively, the data conversion may be done at the third party e-commerce website.

Still referring to FIG. 5, in another embodiment, a wallet public API 506 may be provided with a collection of application interfaces, which third parties may sign to access the electronic wallet core 504 from an application executing on the wireless mobile device 100. In this case, the third party application running on the device 100 and the wallet public API 506 is the external trigger for invoking the electronic wallet application and the electronic wallet core 504. Upon invocation, the electronic wallet core 504 may take over the currently active screen of the application running on the wireless mobile device 100 in order for the user to choose/add/edit cards. Each card type (e.g. credit card, gift card, loyalty card, login credential, address, user information) may have its own screen with specific data fields.

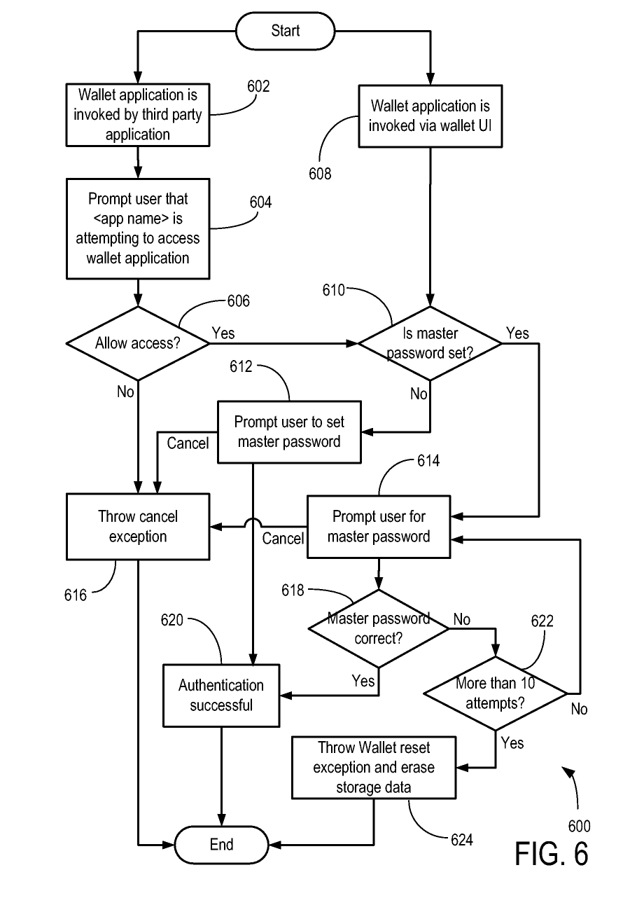

Now referring to FIG. 6, shown is an illustrative wallet authentication process 600 for authenticating a user. As shown, wallet authentication method 600 may begin at block 602, where the wallet application is invoked by a third party application. In step 604, method 600 prompts that an external application with a particular <app name> is attempting to access the wallet application. Method 600 then proceeds to decision block 606 to determine whether or not to allow access. If yes, method 600 proceeds to decision block 610. If no, method 600 proceeds to block 616.

Alternatively, if a wallet application is invoked via a wallet UI at block 608, method 600 proceeds directly to decision block 610. At decision block 610, the method determines whether a master password is set. If no, method 600 proceeds to block 612, where method 600 prompts the user to set the master password. If yes, method 600 proceeds instead to block 614, where method 600 prompts the user for a master password. From block 612 and 614, if the user cancels the operation, method 600 proceeds to block 616 where method 600 throws a cancel exception (e.g. using a “throw” command used in exception handling), and ends. Otherwise, from block 612, method 600 proceeds to block 620, and from block 614, method 600 proceeds to decision block 618.

At decision block 618, method 600 determines if the master password is correct. If yes, method 600 proceeds to block 620. At block 620, method 600 successfully authenticates the master password and ends. If no, method 600 proceeds to decision block 622 to determine if more than 10 password attempts have been made. If no, method 600 returns to block 614. If yes, method 600 proceeds to block 624 to throw a wallet reset exception, and erase storage data. Method 600 then ends.

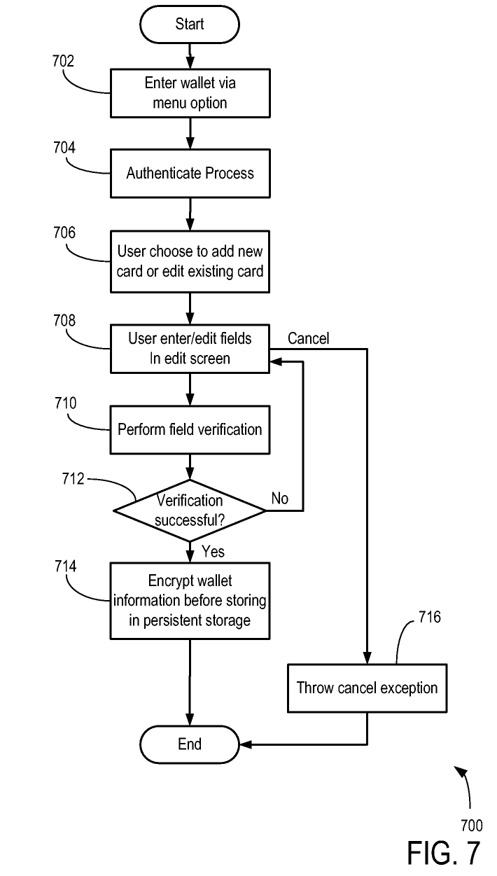

Now referring to FIG. 7, shown is a method 700 for adding or editing a card in the electronic wallet core 504. Method 700 begins, and at block 702 enters the wallet via a menu option. Method 700 then proceeds to block 704, and enters the authentication process already described with reference to FIG. 6. Method 700 then proceeds to block 706, where method 700 allows the user to choose to add a new card, or to edit an existing card.

Method 700 then proceeds to block 708, where method 700 allows the user to enter or edit fields in edit screens provided in a wallet UI. At block 708, if the user cancels the enter/edit operation, method 700 proceeds to block 716, where method 700 throws a cancel exception. Method 700 then ends. Otherwise, method 700 proceeds to block 710 to perform verification of the field inputs. Method 700 then proceeds to decision block 712, where method 700 determines if the verification has been successful. If no, method 700 returns to block 708. If yes, method 700 proceeds to block 714.

At block 714, method 700 encrypts the wallet information before storing the wallet information in persistent storage. Method 700 then ends.

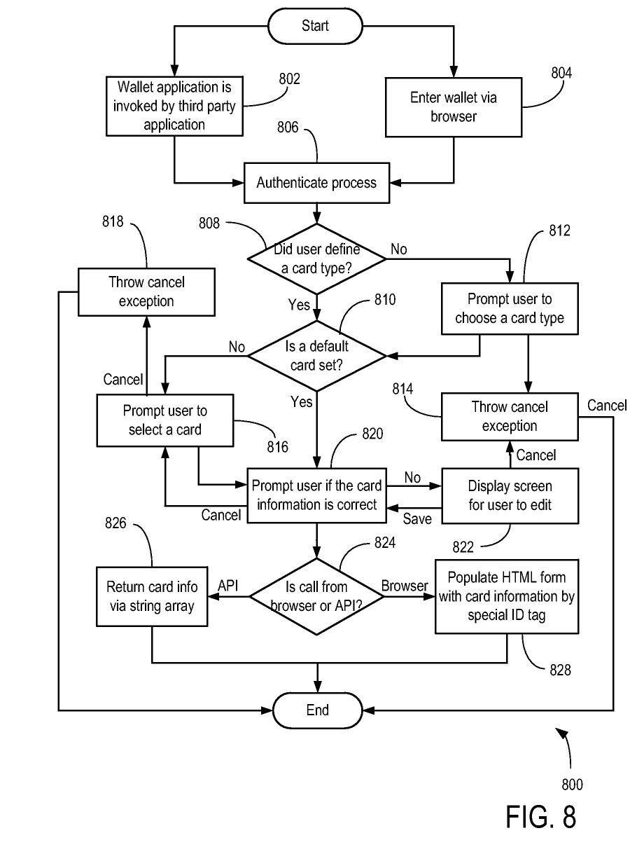

Now referring to FIG. 8, shown is a schematic flowchart of an illustrative method 800 for invoking the electronic wallet core 504. As shown, a wallet application may be invoked by a third party application as at block 802, or via an Internet browser as at block 804. In either instance, method 800 proceeds to block 806 to undergo an authentication process, as previously described with respect to FIG. 6.

From block 806, method 600 proceeds to decision block 808, where method 800 determines if the user has defined a card type. If yes, method 800 proceeds to decision block 810. If no, method 800 instead proceeds to block 812, where the user is prompted to choose a card type.

At block 812, if a user cancels, method 800 proceeds to block 814 to throw a cancel exception, and method 800 then ends. Otherwise, method 800 proceeds to decision block 810. At decision block 810, method 800 determines if the user defined card type is a default card set. If yes, method 800 proceeds directly to block 820. If no, method 800 proceeds to block 816, where method 800 prompts the user to select a card. If the user cancels, method 800 proceeds to block 818 to throw a cancel exception, and then ends. Otherwise, method 800 proceeds to block 820.

At block 820, method 800 prompts the user if the card information is correct. If the user cancels, method 800 returns to block 816. If no, method 800 proceeds to block 822 to display a screen with the card information for the user to edit. If the user cancels, method 800 proceeds to block 814 to throw a cancel exception and then ends. Otherwise, any information entered by the user at block 822 is saved and method 800 returns to block 820. Upon confirming the card information is correct at block 820, method 800 proceeds to decision block 824.

At decision block 824, method 800 determines if the call is from the browser or the API. If the API, method 800 proceeds to block 826 and returns card information, for example in a string array format. If the browser, method 800 proceeds to block 828, where method 800 populates an HTML form with card information, for example using a HTML field ID tag. Method 800 then ends.

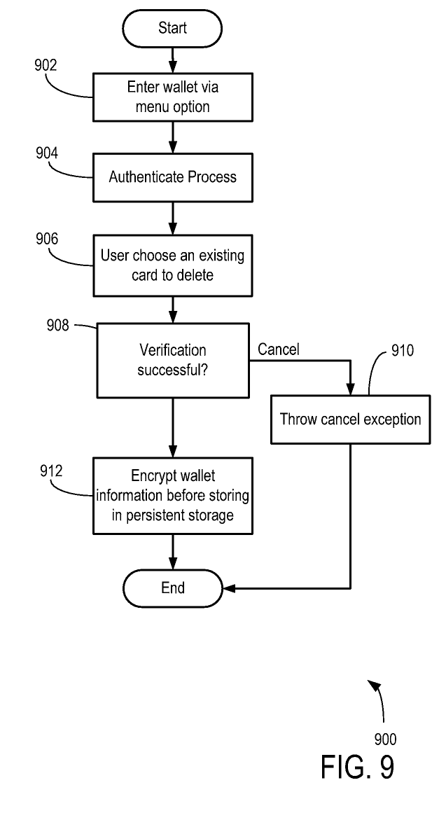

Now referring to FIG. 9, shown is a schematic flowchart of an illustrative method 900 for deleting a credit card from the electronic wallet. As shown, at block 902, method 800 enters the wallet via a menu option.

Method 900 then proceeds to block 904, where method 900 goes through the authentication process, as previously described with reference to FIG. 6. Method 900 then proceeds to block 906, where method 900 allows the user to choose an existing card to delete. Method 900 then proceeds to block 908, where method 900 determines if the verification is successful. If a request to cancel is received via a user input, method 900 proceeds to block 910 to throw a cancel exception and then ends. Otherwise, method 900 proceeds to block 912, where method 900 encrypts the wallet information before storing in persistent storage.

Thus, in an aspect of the invention, there is provided an electronic wallet for a wireless mobile device, the electronic wallet comprising: wallet invocation means responsive to an external trigger originating externally from the wallet; user authentication means for authenticating a user of the electronic wallet upon invocation of the wallet in response to the external trigger; and means for returning card information stored in the wallet for automatic population of a form specified by the external trigger.

In an embodiment, the external trigger comprises a webpage accessed via an Internet web browser on the wireless mobile device, the webpage having a wallet trigger instruction embedded therein.

In another embodiment, the wallet trigger instruction comprises an extension embedded into the header of the webpage accessed via the Internet web browser.

In another embodiment, the extension is a MIME type, and the extension is embedded into an HTTP header of the webpage accessed via the Internet web browser.

In another embodiment, the webpage accessed via the Internet web browser further includes field ID tags mapping specific data fields in the wallet to form input fields provided in the webpage.

In another embodiment, the external trigger invoking the wallet comprises a third party software application executing on the wireless mobile device.

In another embodiment, the third party software application is configured to select card information returned from the wallet based on data fields required to populate form input fields on a remote server.

In another aspect, there is provided a method of providing payment information from an electronic wallet for a wireless mobile device, comprising: invoking the wallet in response to an external trigger originating externally from the wallet; authenticating the user of the electronic wallet upon invocation of the wallet by the external trigger; and returning card information stored in the wallet for automatic population of a form specified by the external trigger.

In an embodiment, the external trigger is a webpage accessed via an Internet web browser on the wireless mobile device, the webpage having a wallet invocation instruction embedded therein.

In another embodiment, the wallet invocation instruction is an extension embedded into the header of the webpage accessed via the Internet web browser.

In another embodiment, the extension is a MIME type, and the extension is embedded in an HTTP header of the webpage accessed via the Internet web browser.

In another embodiment, the webpage accessed via the Internet web browser includes field ID tags mapping specific data fields in the electronic wallet to form input fields provided in the webpage.

In another embodiment, the external trigger invoking the wallet comprises a third party software application executing on the wireless mobile device.

In another embodiment, the third party software application is configured to select card information returned from the wallet based on data fields required to populate form input fields on a remote server.

In another aspect, there is provided a data processor readable medium storing data processor code that when loaded onto a wireless mobile device adapts the device to provide payment information from an electronic wallet for a wireless mobile device, the data processor readable medium comprising: code for invoking the wallet in response to an external trigger originating externally from the wallet; code for authenticating the user of the electronic wallet upon invocation of the wallet by the external trigger; and code for returning card information stored in the wallet for automatic population of a form specified by the external trigger.

In another embodiment, the external trigger is a webpage accessed via an Internet web browser on the wireless mobile device, the webpage having a wallet trigger instruction embedded therein.

In another embodiment, the wallet trigger instruction is an extension embedded into the header of the webpage accessed via the Internet web browser.

In another embodiment, the extension is a MIME type, and the extension is embedded in an HTTP header of the webpage accessed via the Internet web browser.

In another embodiment, the webpage accessed via the Internet web browser includes field ID tags mapping specific data fields in the electronic wallet to form input fields provided in the webpage.

In another embodiment, the external trigger invoking the wallet comprises a third party software application executing on the wireless mobile device.

In another embodiment, the third party software application is configured to select card information returned from the wallet based on data fields required to populate form input fields on a remote server.

In another aspect, there is provided a method of providing payment information from an electronic wallet for a wireless mobile device, comprising: invoking the wallet in response to an external trigger originating externally from the wallet; authenticating the user of the electronic wallet upon invocation of the wallet by the external trigger, the external trigger being a wallet trigger instruction embedded in one of a webpage accessed via an Internet web browser or a third party software application executing on the wireless mobile device; and returning card information stored in the wallet for automatic population of a form specified by the external trigger.

While illustrative embodiments have been described above, it will be appreciated that various changes and modifications may be made. More generally, the scope of the invention is defined by the following claims.

What is claimed is:

1. An electronic wallet for a wireless mobile device, the electronic wallet comprising:
wallet invocation means responsive to an external trigger originating externally from the wallet;
user authentication means for authenticating a user of the electronic wallet upon invocation of the wallet in response to the external trigger; and
means for returning card information stored in the wallet for automatic population of a form specified by the external trigger.

2. The electronic wallet of claim 1, wherein the external trigger comprises a webpage accessed via an Internet web browser on the wireless mobile device, the webpage having a wallet trigger instruction embedded therein.

3. The electronic wallet of claim 2, wherein the wallet trigger instruction comprises an extension embedded into the header of the webpage accessed via the Internet web browser.

4. The electronic wallet of claim 3, wherein the extension is a MIME type, and the extension is embedded into an HTTP header of the webpage accessed via the Internet web browser.

5. The electronic wallet of claim 2, wherein the webpage accessed via the Internet web browser further includes field ID tags mapping specific data fields in the wallet to form input fields provided in the webpage.

6. The electronic wallet of claim 1, wherein the external trigger invoking the wallet comprises a third party software application executing on the wireless mobile device.

7. The electronic wallet of claim 6, wherein the third party software application is configured to select card information returned from the wallet based on data fields required to populate form input fields on a remote server.

8. A method of providing payment information from an electronic wallet for a wireless mobile device, comprising:
invoking the wallet in response to an external trigger originating externally from the wallet;
authenticating the user of the electronic wallet upon invocation of the wallet by the external trigger; and
returning card information stored in the wallet for automatic population of a form specified by the external trigger.

9. The method of claim 8, wherein the external trigger is a webpage accessed via an Internet web browser on the wireless mobile device, the webpage having a wallet invocation instruction embedded therein.

10. The method of claim 9, wherein the wallet invocation instruction is an extension embedded into the header of the webpage accessed via the Internet web browser.

11. The method of claim 10, wherein the extension is a MIME type, and the extension is embedded in an HTTP header of the webpage accessed via the Internet web browser.

12. The method of claim 9, wherein the webpage accessed via the Internet web browser includes field ID tags mapping specific data fields in the electronic wallet to form input fields provided in the webpage.

13. The method of claim 8, wherein the external trigger invoking the wallet comprises a third party software application executing on the wireless mobile device.

14. The method of claim 13, wherein the third party software application is configured to select card information returned from the wallet based on data fields required to populate form input fields on a remote server.

15. A data processor readable medium storing data processor code that when loaded onto a wireless mobile device adapts the device to provide payment information from an electronic wallet for a wireless mobile device, the data processor readable medium comprising:
code for invoking the wallet in response to an external trigger originating externally from the wallet;
code for authenticating the user of the electronic wallet upon invocation of the wallet by the external trigger; and
code for returning card information stored in the wallet for automatic population of a form specified by the external trigger.

16. The data processor readable medium of claim 15, wherein the external trigger is a webpage accessed via an Internet web browser on the wireless mobile device, the webpage having a wallet trigger instruction embedded therein.

17. The data processor readable medium of claim 16, wherein the wallet trigger instruction is an extension embedded into the header of the webpage accessed via the Internet web browser.

18. The processor readable medium of claim 17, wherein the extension is a MIME type, and the extension is embedded in an HTTP header of the webpage accessed via the Internet web browser.

19. The data processor readable medium of claim 16, wherein the webpage accessed via the Internet web browser includes field ID tags mapping specific data fields in the electronic wallet to form input fields provided in the webpage.

20. The data processor readable medium of claim 15, wherein the external trigger invoking the wallet comprises a third party software application executing on the wireless mobile device.

21. The data processor readable medium of claim 20, wherein the third party software application is configured to select card information returned from the wallet based on data fields required to populate form input fields on a remote server.

22. A method of providing payment information from an electronic wallet for a wireless mobile device, comprising:
invoking the wallet in response to an external trigger originating externally from the wallet;
authenticating the user of the electronic wallet upon invocation of the wallet by the external trigger, the external trigger being a wallet trigger instruction embedded in one of a webpage accessed via an Internet web browser or a third party software application executing on the wireless mobile device; and
returning card information stored in the wallet for automatic population of a form specified by the external trigger.
